(19) United States
(12) Patent Application Publication
(10) Pub. No.: US 2009/0188390 A1
(43) Pub. Date: Jul. 30, 2009

(54) ELECTROSTATIC PRECIPITATOR

(76) Inventor: Maurice Daverell Walker, Salisbury (GB)

Correspondence Address: JOHN S. PRATT, ESQ;KILPATRICK STOCKTON, LLP, 1100 PEACHTREE STREET, SUITE 2800, ATLANTA, GA, 30309, US

(21) Appl. No.: 12/438,139

(22) PCT Filed: Aug. 23, 2007
(86) PCT No.: PCT/GB2007/003204

§ 371 Date: Feb. 27, 2009

(30) Foreign Application Priority Data
Aug. 26, 2006 (GB) 0616916.3

(51) Int. Cl. B03C 3/06; B03C 3/49; B03C 3/10

(52) U.S. Cl. 96/27

(57) ABSTRACT

There is provided an electrostatic precipitator comprising air inlet means to a conduit for the passage of an air flow containing particles and means generating a focusing electrostatic field within the conduit substantially orthogonal to the air flow in which the generating means comprise a two dimensional surface electrode including an ion source and an earthed counter electrode and in which the air inlet means and the surface electrode are adapted to direct ion substantially against the direction of the air flow in the conduit.

The present invention is concerned with an electrostatic precipitator which is suitable for the collection of airborne particles from an environment. It is particularly, although not exclusively, directed to an electrostatic precipitator capable of collecting biological particles which are airborne in an environment.

The collection for analysis of particles from air often relies on impaction of the particles to a collecting surface by acceleration of the air to very high velocities. Such impaction techniques are, however, inefficient for the collection of small particles (means diameter about 1 μm) and often require a very high energy input.

The removal of dust and other particles by electrostatic precipitation is a well-known technique which finds application on an industrial scale for scrubbing of effluent gases or air.

However, little attention has been paid to electrostatic precipitation as a technique for collecting particles for analysis. Indeed most electrostatic precipitators are unsuitable for efficient collection of particles from an environment in that the collecting surface is relatively large and consequently only dilute particle samples can be obtained.

One approach to the problem of efficient collection utilises a miniature electrostatic precipitator (InnovaTek USA) comprising a number of collecting plates with micro-machined channels to which particles are deposited. The particles are collected by a minimum volume of collecting fluid.

European patent application EP 0 239 865 discloses an electrostatic precipitator for removing particles from a gas stream. The precipitator includes a cylindrical electrode arrangement comprising a corona discharge ion source and a counter electrode whereby charged particles are directed toward the counter electrode but are collected below it.

A similar approach, developed by Applicant, attempts to tightly focus particles charged by corona discharge field to a point surface. The arrangement uses a corona discharge ion source and a series of focusing ring electrodes of identical polarity to the charge developed on the particles whereby to direct them toward a counter electrode comprising a co-axially mounted pin.

This approach is, however, unsatisfactory for the efficient collection of particles in that, even when particle size is increased by condensation, the extent of charge developed on the particles at desired air flows is non-uniform. Furthermore, the focusing field acting on the particles at desired operating potentials often fails to overcome drag effects or arrests the exit of particles from the charging field. Consequently, only a proportion of the particles passing through the focusing field are driven toward the counter electrode.

International Patent Application PCT/GB2003/004886, incorporated by reference herein in its entirety, discloses an electrostatic precipitator suitable for the collection of particles for analysis. The precipitator includes a plasma ion source which enables much more uniform charging of particles.

The present invention is also concerned with focusing particles to a counter electrode but unlike the prior art it seeks to achieve this object by harnessing the effects of corona wind.

Accordingly, the present invention provides an electrostatic precipitator comprising air inlet means to a conduit for the passage of an air flow containing particles and means generating a focusing electrostatic field within the conduit substantially orthogonal to the air flow in which the generating means comprise a two dimensional surface electrode including an ion source and an earthed counter electrode and in which the air inlet means and the surface electrode are adapted to direct ions substantially against the direction of the air flow in the conduit.

It will be understood that the focusing field drives ions and particles toward the earthed counter electrode and that it is those ions not reaching the counter electrode that are directed against the air flow.

In a preferred embodiment, both the conduit and the surface electrode are cylindrical in shape. In this embodiment, the air inlet means may comprise a part of the housing for the precipitator which is independently supported over the upper portion of the conduit relative to the direction of the air flow therein. The air inlet means may together with the conduit define a restricted passage for the intake of air from without the housing.

Most preferably, the housing and air inlet means are cylindrical in shape and together define an omni-directional opening for the intake of air.

In a preferred embodiment the surface electrode is arranged within the conduit so that the ion source is positioned within an upper portion of the conduit. Most preferably, it is arranged so that the ion source is positioned above the focusing portion.

It will be apparent that the cross sectional diameter of the conduit is larger than that of the surface electrode whereby the field developed between the electrode and the inner surface of the upper portion of the conduit tends to cause the ions not reaching the counter electrode to move away toward the air inlet means.

In one embodiment, the air inlet means is earthed whereby to also tend to cause ions not reaching the counter electrode to move towards it and away from the charged surface electrode.

Preferably the conduit comprises a material of low to medium surface resistivity (in the order of 10¹³ Ωm). Most preferably the material is also of high bulk conductivity (in the order of 10¹⁴ S/m) whereby to ensure controlled surface charging on its inner surface and low charge leakage.

In a preferred embodiment the outer surface is earthed and/or the upper portion of the conduit is inwardly tapered towards an upper edge whereby to tend to minimise the deposition of particles. The angle of taper is preferably 20° but other angles, for example, 30°, 35°, 40° and 45° may also be possible.

Most preferably the counter electrode comprises an elongate member of substantially circular cross section. It may, in particular, comprise a rod, wire or pin which is co-axially mounted within the conduit although other arrangements are also possible.

In a preferred embodiment, the counter electrode comprises a belt of a conductive, preferably elastomer, material. The belt is preferably of substantially circular cross section so as to minimise the collection area.

In one embodiment the belt is endless and supported by a pulley arrangement which may be associated with a drive means. Preferably, the belt and pulley arrangement are such that the belt extends along the whole longitudinal length of the conduit and the air inlet means.

The belt is preferably associated with a collection means which may in particular, comprise a liquid wash pot through which the belt must travel. The wash pot includes a hydraulic rod seal which operates to remove most of the liquid from the belt as it exits.

The action of the hydraulic rod seal to remove most, if not all, the liquid from the belt enables minimal liquid to be used for collection, and thus provides for rapid concentration of particles. Concentration is further enhanced with a belt of substantially circular cross section.

It is known to use belts and wash pots in scrubbing precipitators—see Dutch patent application 8000042—but only for keeping the counter electrode clean and not for collecting particles for analysis.

In a preferred embodiment the ion source comprises a plurality of corona discharge pins—which may be arranged in a circular array on the surface electrode. In addition, each pin may be associated with a high value resistor so as to provide for current balancing and even ion distribution.

Alternatively, the ion source may comprise a plasma electrode or plasma electrodes as is described in international patent application PCT/GB2003/004886.

It will be appreciated that the practice of the present invention to some extent depends on the appropriate selection of a large number of parameters—such as particle size, potential, relative dimension and position of the air inlet means, conduit and surface electrode and rate of air flow.

In a preferred embodiment the efficient collection of small particles to 1 ml liquid (water) at acceptable potentials and air flow rate (air pump, 700 standard litres per minute) could be achieved using a cylindrical conduit of internal cross sectional diameter 100 mm, a cylindrical surface electrode of internal cross sectional diameter 80 mm, a belt of circular cross section 20 mm, an ion source comprising about 30 to 40 corona pins (5 mm long, optimal 36 pins) and positioned 60 mm below the upper edge of the conduit and air inlet means of internal cross sectional diameter and height 200 mm positioned 90 mm above the upper edge of the conduit.

Those skilled in the art will appreciate, however, that the present invention harnesses the corona wind to drive ion flow upstream of the ion source. It therefore provides the advantage that the particles become charged before they enter the conduit which enables a highly compact and portable device.

The present invention will now be described by reference to a preferred embodiment and the following drawings in which

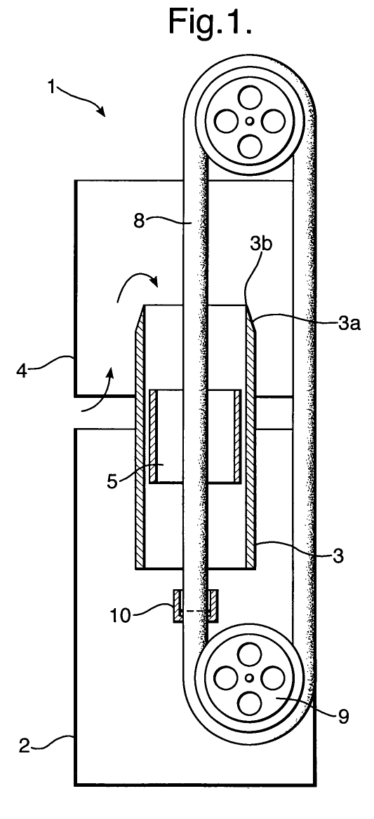

FIG. 1 is a schematic representation of a preferred embodiment of the present invention;

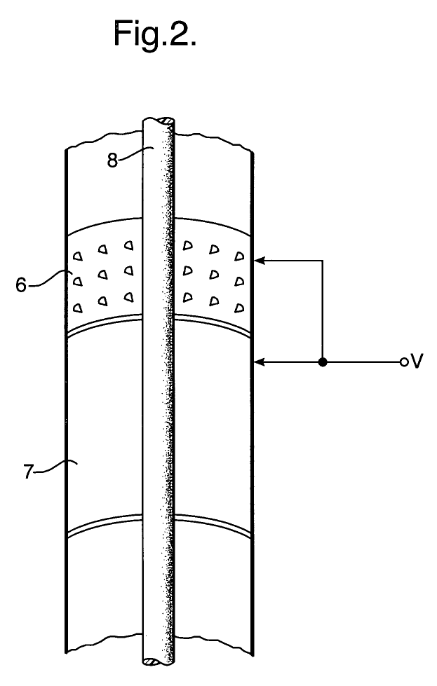

FIG. 2 is a section view of part of the conduit in this embodiment showing the surface electrode; and

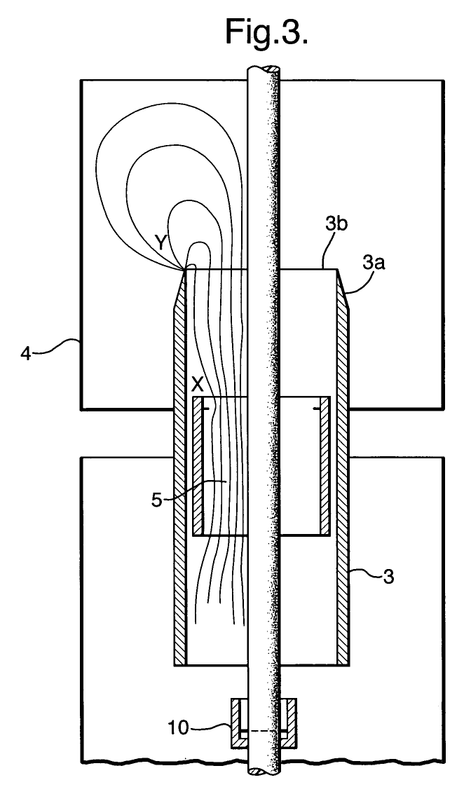

FIG. 3 is a section view generally representing the electrostatic field developed when this embodiment is use.

Having regard now to FIG. 1, there is shown an electrostatic precipitator, generally designated 1, which comprises a cylindrical housing 2 in which a conduit 3 for the passage of an air flow comprising particles is centrally disposed.

The conduit 3, which comprises polyvinylchloride, is generally tubular in shape and has internal cross sectional diameter 100 mm. An upper portion 3a of the outer surface of the conduit is tapered at 20° to toward an edge 3b.

The housing 2, which comprises a conductive material, generally consists of two half cylinder portions which are independently supported above and below the conduit 3. The upper portion of the housing comprises an air inlet means 4 which together with the lower portion defines an annular aperture for the intake of air to the precipitator. The air inlet means 4 also defines together with the outer surface of the conduit 3 provides a restricted passage (shown by arrow) for the transport of the air intake to the conduit 3.

The air inlet means 4, which is earthed, has an internal cross sectional diameter and length of 200 mm and is positioned over and above the conduit 3 so that its end is 90 mm from the upper edge 3b.

Referring also to FIG. 2, a surface electrode 5 comprises a plastic tube of length 80 mm which is positioned 60 mm below the upper edge 3a of the conduit. This position minimises the likelihood of flashover and surface tracking. The tube is provided with an ion source 6 in its upper portion and a copper tape 7 in its lower portion. The ion source comprises a circular array of 36 corona pins each of which is linked to a high voltage power supply (˜10⁴ V) via a high value resistor (1 GΩ, not shown) to allow ion current balancing (5 μA).

The air inlet means 4 defines an aperture in its end portion for an earthed conductive elastomer belt 8 of circular cross section which supported on a pulley arrangement 9 and mounted so that it extends centrally through the air inlet means 4 and conduit 3 to the lower portion of the housing 2.

A wash pot, generally designated 10, is mounted in a lower portion of the housing 2 below the conduit 3 so that the belt also extends centrally there through. The wash pot which has volume of about 1 ml comprises a hydraulic rod seal which operates to retain collecting fluid in the wash pot.

Referring also now to FIG. 3, an air flow containing particles is introduced to the air inlet means 4 by an air pump (not shown) where it encounters the electrostatic field. As may be seen, the electrostatic field is outwardly tapered in the region X between the inner surface of the conduit and the surface electrode. As a result the ions not reaching the counter electrode spiral upwards toward the air inlet means. The transport of ions to this region means that particles in the air flow approaching the conduit are to a significant extent charged before they reach the conduit 3.

Also seen is the curvature of the electrostatic field in the region Y of the upper edge 3a of the conduit 3. The shape of the field in this region means that the particles moving in the air flow are slowed and consequently tend not deposit on the outer surface of the upper portion of the conduit 3.

The majority of particles are focused by the field and deposit on the belt above or in the region of the upper portion of the conduit. The belt 8, driven by the pulley arrangement, travels through the wash pot 10 where the particles are removed to a collecting fluid such as water.

The preferred embodiment of the invention referred to in FIG. 1 has been shown to consistently collect and recover biological material (Bacillus subtilis var. niger spores) from the air into a liquid sample with good collection efficiencies.

1. An electrostatic precipitator comprising air inlet means to a conduit for the passage of an air flow containing particles and means generating a focusing electrostatic field within the conduit substantially orthogonal to the air flow in which the generating means comprise a two dimensional surface electrode including an ion source and an earthed counter electrode and in which the air inlet means and the surface electrode are adapted to direct ions substantially against the direction of the air flow in the conduit.

2. An electrostatic precipitator according to claim 1, in which the air inlet means is earthed.

3. An electrostatic precipitator according to claim 1, in which the surface electrode is positioned within an upper portion of the conduit.

4. An electrostatic precipitator according to claim 3, in which the surface electrode has substantially smaller diameter than that of the conduit.

5. An electrostatic precipitator according to claim 1, in which the conduit comprises a material of bulk conductivity in the order 10¹⁴ S/m and resistivity in the order of 10¹³ Ωm.

6. An electrostatic precipitator according to claim 6, in which the conduit comprises an outer surface which is earthed and inwardly tapers to an upper edge.

7. An electrostatic precipitator according to claim 1, in which the counter electrode comprises an elongate element of substantially circular cross section.

8. An electrostatic precipitator according to claim 7, in which the counter electrode comprises a conductive belt.

9. An electrostatic precipitator according to claim 8, further comprising means for collecting particles from the belt.

10. An electrostatic precipitator according to claim 9, in which the collecting means comprise a liquid bath.

11. An electrostatic precipitator according to claim 1, in which the ion source comprises a plurality of corona pins.

12. An electrostatic precipitator according to claim 1, in which the ion source comprises a plasma electrode.

13. An electrostatic precipitator according to claim 1, in which the surface electrode and the counter electrode are substantially cylindrical in shape.

14. (canceled)
